(19) United States
(12) Patent Application Publication
(10) Pub. No.: US 2002/0017768 A1
(43) Pub. Date: Feb. 14, 2002

(54) Rollerboard

(76) Inventor: Moamar Nardone, Munchen (DE)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 09/810,597

(22) Filed: Mar. 16, 2001

(30) Foreign Application Priority Data
Apr. 4, 2000 (DE) 100 16 635.0
Nov. 30, 2000 (DE) 200 20 344.4

(51) Int. Cl. B62M 1/00; B62L 1/04; A63C 17/14

(52) U.S. Cl. 280/87.041; 280/87.05

(57) ABSTRACT

The present invention relates to a roller board having a longitudinal axis extending in running direction, including: a footboard for a user to stand thereon and having front and rear end portions in running direction; at least one wheel at the rear end portion of the footboard; two steerable wheels at the front end portion of the footbard each offset to a side of the longitudinal axis; a steering mechanism having the two steerable wheels mounted thereon and being mounted at the front end portion of the footboard such that pivoting of the footboard about its longitudinal axis effects turning of the front wheels; and a control rod connected to the footboard and adapted to be held by the user during his ride.

The present invention relates to a roller board having a longitudinal axis extending in running direction, comprising:

(a) a footboard provided for a user to stand thereon and having front and rear end portions in running direction;

(b) at least one wheel provided at the rear end portion of said footboard,

(c) two steerable wheels provided at the front end portion of said footboard each offset to a side of said longitudinal axis,

(d) a steering mechanism having the two steerable wheels mounted thereon and being mounted at the front end portion of the footboard such that pivoting of said footboard about its longitudinal axis effects turning of said front wheels; and

(e) a control rod connected to the footboard and adapted to be held by the user during his ride. Such devices, having features of children's scooters, skateboards and inline skaters, have been introduced into the market very recently and may very well become trendy sports equipment, as it was also the case with skateboards and in-line skaters, respectively. A disadvantage of devices that can be purchased so far is the relatively high price thereof, which in part is due to the very complex construction. For example, the steering mechanism in a commercially available embodiment is formed with two front wheels individually suspended in turnable manner, which is correspondingly complex in manufacture.

It is thus an object of the present invention to make available a roller board that is of clearly simplified construction.

This object is met according to the invention in that the steering mechanism is designed such that the two front wheels are adapted to be turned in common around a common front wheel longitudinal axis which, in the neutral position, is substantially perpendicular to the connecting line between the two front wheels and substantially vertical to said longitudinal axis.

With this embodiment, the two front wheels can be turned around a single, common front wheel steering axle and thus effect cornering of the roller board. The design with just one steering axle, instead of two steering axles as provided in the prior art so far, provides the advantage that lower measurement accuracy and less accurate adjustment of the individual parts during assembly are required. Accordingly, a clear potential for savings results.

Preferably, there is provided a resetting means for the front wheels, endeavoring to reset the deflected front wheels to the neutral position. Such a resetting means provides for particularly stable straight-running properties, which is very desirable for reasons of driving safety. The stronger the resetting means, the more stable the straight-running properties, but the less rapid the response of the steering mechanism of the roller board to desired changes in direction. It will thus be necessary to weigh between stability on the one hand and maneuverability on the other hand in designing the resetting means.

Preferably, the resetting means is formed by arranging the front wheel steering axle at an angle with respect to the longitudinal axis of the roller board, which is somewhat smaller or somewhat greater than a right angle. It is assumed in this respect that the longitudinal axis of the roller board in the neutral state, i.e. in the straight-running position of the roller board, is parallel to the plane on which the roller board rests, i.e. the virtual plane formed by the points of contact of the wheels with the ground. Any inclined position of the front wheel steering axle with respect to the right angle to this longitudinal axis, has the effect that the plane in which the two front wheels are turned around the front wheel steering axle, is rotated out of the plane of the ground. For the following explanations, it shall be defined as a convention that this angle, beginning from the longitudinal axis to the front wheel steering axle in upward direction, is measured in clockwise direction. Consequently, if the angle is smaller than 90°, the front wheel steering axle is pivoted above the longitudinal axis forwardly in the direction towards the longitudinal axis, and the plane in which the front wheels are turned around the front wheel steering axle, is tilted forwardly and downwardly. For example, if the front wheels are turned around the front wheel steering axle such that the left-hand wheel moves forwardly and the right-hand wheel rearwardly, both of the wheels move on the turning plane, i.e. the left-hand wheel moves forwardly and downwardly, whereas the right-hand wheels moves rearwardly and upwardly. Due to the fact that the roller board rests on the ground with the at least three wheels, this has the effect that the roller board is tilted around its longitudinal axis. With uniform load acting on the footboard of the roller board, this uniform load tends to effect a resetting motion of the two front wheels to the neutral position. The effect is in principle the same if the angle is larger than 90°. The turning plane of the front wheels then will be tilted rearwardly and downwardly, which in cornering has the effect that the footboard will be pivoted towards the outside of the curve. It is basically more favorable when the footboard is pivoted towards the inside of the curve during cornering. This corresponds to the inclined position of the rider and facilitates taking of the inclined position. As an alternative or in addition to the inclined front wheel steering axle, it is also possible, for example, to provide springs or other elastic members as resetting means. For example, the front wheel steering axle may be held in the neutral position by one or two resetting springs.

Preferably, the steering mechanism has a longitudinal pivot axle around which the footboard is pivotable relative to the front wheels and which in its function is provided between front wheel steering axle and footboard. The footboard thus can be pivoted around the longitudinal pivot axle. It is advantageous here as well to have a resetting mechanism taking care that the neutral position is maintained in essence. In this regard, there may be used, for example, one or more springs or other resilient material.

Preferably, there is provided an entraining mechanism converting a pivotal motion of the footboard into a steering motion of the front wheels around the front wheel steering axle. For example, a shaft-like entraining means may be connected to the two front wheels and to the footboard such that a pivotal motion of the footboard effects a turning motion of the front wheels around the front wheel steering axle. Pivoting of the footboard around the longitudinal axis then effects turning into a corner. The steering mechanism then may consist essentially of three components only, which can be manufactured inexpensively and can be coupled together relatively simply. This allows for simple and inexpensive manufacture.

Preferably, the control or steering rod is coupled to the footboard via a pivot bearing by means of which the control rod is adapted to be folded onto the footboard. Preferably, the pivot bearing has an arresting means associated therewith.

In accordance with an alternative embodiment, the present invention relates to a roller board having a longitudinal axis extending in running direction, comprising:

(a) a footboard provided for a user to stand thereon and having front and rear end portions in running direction;

(b) at least one wheel provided at the rear end portion of the footboard,

(c) at least one steerable wheel provided at the front end portion of the footboard,

(d) a control rod connected to the footboard and adapted to be held by the user with a hand during the ride; the roller board being provided with a locking means for securing the control rod in the unfolded position and, in addition thereto, the pivot bearing having an arresting means associated therewith. Roller boards are also used in general especially in cities as means of conveyance, in particular for relatively short distances. Due to their small size it is also possible to carry them along in public transport or other means of traffic. Due to the control rod projecting approximately at right angles, roller boards nevertheless are quite bulky and, despite the relatively low weight thereof, do not permit completely unproblematic transport thereof.

The transportability of roller boards has already been improved in that the control rod of the roller board is connected to the footboard via a pivot bearing so as to be unfoldable from a position substantially parallel to the footboard into a position substantially perpendicular thereto. This design of the roller board permits folding of the control rod of the roller board into a folded position in which the control rod is substantially parallel to the footboard. On the one hand, this provides for a reduction of the dimensions of the roller board in a direction perpendicularly to the footboard; on the other hand, this folding feature of the control rod provides for the possibility of using the control rod as a “handle” for carrying the roller board.

In a commercially available roller board, a locking means in the form of a spring-loaded locking pin attached to the steering rod or a mounting member is provided which in the unfolded position and in the folded position, respectively, of the steering rod lockingly engages a locking opening and thus retains the steering rod in such position.

Seen from the aspect of safety engineering, this solution is not optimum. On the one hand, it may happen that the locking pin is not perfectly locked. On the other hand, the spring may break so that the locking pin is not held safely in the locked position. Folding of the steering rod during a ride may cause serious accidents.

By way of the present invention, the operational safety of the pivot bearing of a roller board is enhanced.

In general, there are various technical possibilities for arranging the steerable front wheel(s) on a roller board. Typically, a single front wheel is mounted directly at the lower end of the control rod (in this embodiment, the term “steering rod” would be more appropriate). The control rod proper is rotatably mounted to the footboard in a steering head bearing, similar to a bicycle handlebar. More typically with two steerable front wheels, a steering mechanism is utilized which is designed such that lateral tilting of the control rod (relative to the longitudinal axis of the roller board) effects turning of the front wheels into a corner. Both types of steering may also be combined with each other. The foldable design of the control rod according to the invention can be realized with both kinds of roller boards. While with the latter design of the roller board, the control rod may be mounted to the footboard directly, the steering head bearing in case of the first steering design typically will be mounted on the footboard via a mounting member.

The reference to “the lower end of the control rod attached to the footboard”, as used hereinafter, is to be understood to comprise both the lower end proper of the control rod and the mounting member.

Preferably, there is provided a locking means for the control rod which secures the control rod in the unfolded position (running or operating position) and preferably is also capable of securing the control rod in its folded position. Without such a securing feature in the unfolded position, it would not be possible to use the control rod as handle for carrying the roller board.

A particularly preferred embodiment of the pivot bearing provides that the pivot bearing has a pair of guide plates between which the lower end of the control rod or the mounting member for the control rod is supported on a pivot axle, and that at least one of the guide plates and the lower end of the control rod or the mounting member, respectively, are penetrated by a locking pin adapted to be displaced between a release position and a locking position approximately at right angles to the pivot plane of the control rod.

Typically, the locking pin may be spring-loaded so that, upon reaching a locking position, i.e. typically corresponding to the upright position of the control rod or—in the folded state of the roller board—corresponding to the position of the control rod pivoted towards the footboard, it is locked automatically so as to maintain the particular position of the control rod. For changing the position of the control rod, the locking pin may be displaced against the spring load acting thereon in order to release the locked state so that the control rod may be pivoted in the desired direction until it reaches the alternative locking position and the locking pin again is lockingly engaged.

In a particularly advantageous embodiment, it is provided according to the invention that one of the guide plates has an arcuate locking pin guide means formed therein which is concentric with respect to the pivot axle and has a locking position defined at each of its ends. The two locking positions preferably correspond to the operating position, i.e. the approx. vertical position of the control rod, and the folded position of the control rod, i.e. approx. parallel to the footboard.

For additional fixing and holding the control rod in the locked position, it is provided according to a preferred embodiment of the invention that the pivot bearing has an arresting means associated therewith, which in turn in particularly preferred manner has, in each guide plate, an arcuate guide hole which is concentric with respect to the pivot axle and through each of which extends a trunnion, coupled to the control rod, at right angles to the pivot plane of the control rod, with said trunnion being adapted to be arrested by a clamping mechanism at the paired ends of the elongate guide holes.

The control rod preferably can be folded by approx. 90° in the direction towards the footboard. Usual values are in the range of 85°.

Preferably, the pivot bearing is releasably mounted to the footboard. Footboards usually are made of laminated wood or aluminum and, during operation, are subject to high loads and high wear. The operational safety of the roller board typically is not impaired thereby, but the roller board may be affected in its appearance by wear. In case of fixed attachment of the pivot bearing on the footboard, the sole possibility left is the purchase of a new roller board. However, if releasable attachment is provided for, the footboard may be replaced easily—in particular as the rear wheel and the brake usually are releasably mounted on the footboard as well. The replaceability of the footboard furthermore has the advantage that different footboards, resulting in different running properties, may be provided for a footboard. This may be desirable in particular for the more sportive range. For example, longer footboards may be preferred for a more stable running behavior, or elastic footboards may be preferred for artistic performances with the roller board.

To this end, there is preferably provided a mounting plate on the pivot bearing. The mounting plate and the pivot bearing may be attached to the footboard, for example, in the manner of a ski binding.

The lower end of the control rod or of the mounting member preferably is designed such that, in the unfolded state of the control rod (operating position), a sufficiently large distance is left between the lower end of the control rod or the lower end of the mounting member, respectively, and the footboard or the mounting plate for the pivot bearing, so that clamping of objects or body parts therebetween is substantially avoided. In particular, it is preferred if the distance therebetween is at least the width of a finger, i.e. at least 1 cm, preferably 2 cm and more.

Roller boards were introduced into the market recently that have pivoting mechanisms in which there is virtually no distance present between the lower end of the control rod or the lower end of the mounting member and the footboard or the mounting plate, respectively. Furthermore, there is in particular the fact with such roller boards that the lower end of the mounting member is in the form of a rectangular tube with sharp edges. The use of such roller boards led to serious accidents in which in some cases even fingers were severed off completely. The roller boards distributed by the applicant, for reasons of safety, had from the very beginning a construction such that the mounting members of rectangular tubular shape, at the lower end thereof, were designed to leave sufficient space for avoiding such accidents. In these roller boards of the applicant, the lower ends of the mounting members in particular have been tapered to such an extent that a sufficient distance is formed. The lower end of the mounting member or of the control rod, respectively, therefore is preferably tapered such that a sufficiently large distance is created between this end and the footboard or the mounting plate.

Preferably, the lower end of the control rod or of the lower end of the mounting member is closed. For covering the same, for example, a cover of plastics material may be provided.

The roller board preferably is provided with a brake means and the brake means preferably is activated by a movement of the control rod, it being particularly preferred that pivoting of the control rod in forward direction triggers a braking operation. As an alternative thereto, the brake means can also be activated by foot operation. In this case, it is expedient to use the standing leg, usually situated to the rear, for activating the brake. If the control rod is used for initiating a braking operation, it is preferred to provide a brake locking means that permits pivoting of the control rod in forward direction only after the same has been unlocked before. It is thus prevented that accidental forward leaning against the control rod causes initiation of a braking operation which is further increased by the ensuing forward leaning due to such braking, and finally has the effect that the user can no longer keep his balance and falls from the roller board in forward direction. Preferably, the unlocking means is provided at the upper end of the control rod and pivoting of the control rod in forward direction is possible after operation of said unlocking means only.

Preferably, the brake means has at least one brake roller and at least one displacement means which, for effecting a braking operation, brings the at least one brake roller in contact with at least one of the wheels for effecting a deceleration. It is advantageous that the brake roller is contacted with, i.e. urged against, the wheel for a braking operation only, thus avoiding deterioration of the rolling properties of the roller board during ordinary use. It is advantageous to provide the displacement means in the form of a carriage or a thrust bar having the at least one, but preferably all, brake rollers mounted thereon. This carriage may be attached in a guide means, for example, below the footboard e.g. by engaging a kind of groove and being guided thereby. Via a lever mechanism, this carriage can be displaced, for example, towards the rear upon forward movement of the control rod, thereby engaging the brake roller with the wheel. It is expedient to design the means for transferring the forward motion of the control bar to the brake roller such that the fulcrums and the lengths of the lever arms or the points of application of the force are chosen such that favorable ratios of force are obtained, i.e. force increase or force decrease for example.

In an alternative preferred embodiment of the brake means, the latter has a foot brake lever pivotably supported at the rear end of the footboard, which is coupled to a friction mechanism acting on the rear wheel. This friction mechanism in turn contains a brake roller acting simultaneously on the rear wheel and a brake pad, so that the brake pad decelerates the brake roller and the brake roller in turn decelerates the rear wheel. In this regard, the alternative brake device is similar to the brake device described hereinbefore. The alternative brake means is provided, as actuating means, with the foot brake lever, thus permitting easy deceleration in that the user simply presses the foot brake lever with the heel of a foot.

The invention will be described in more detail hereinafter by way of embodiments; in the drawings:

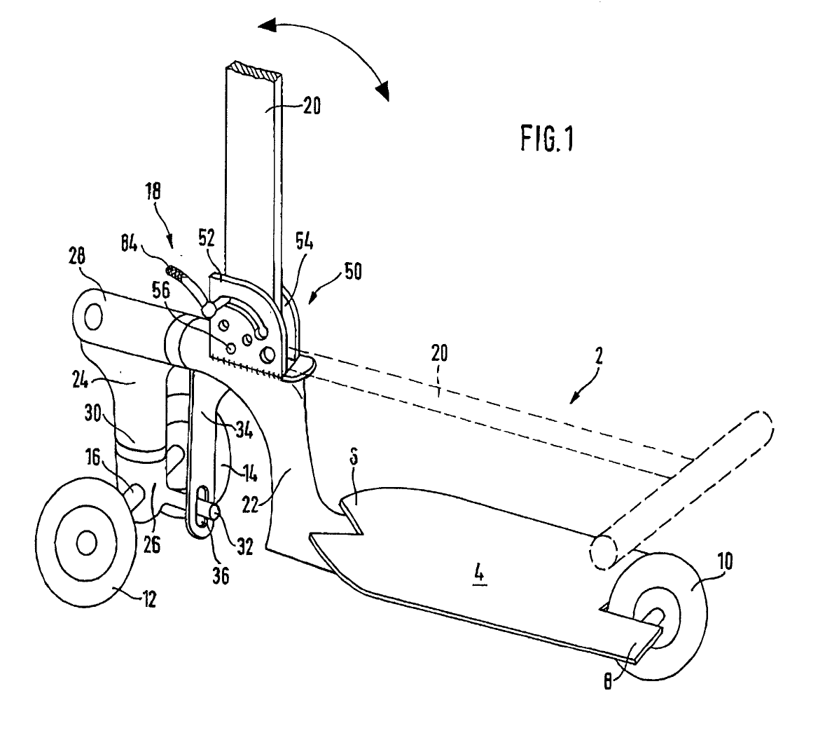

FIG. 1 shows an embodiment of a roller board according to the invention in a perspective view;

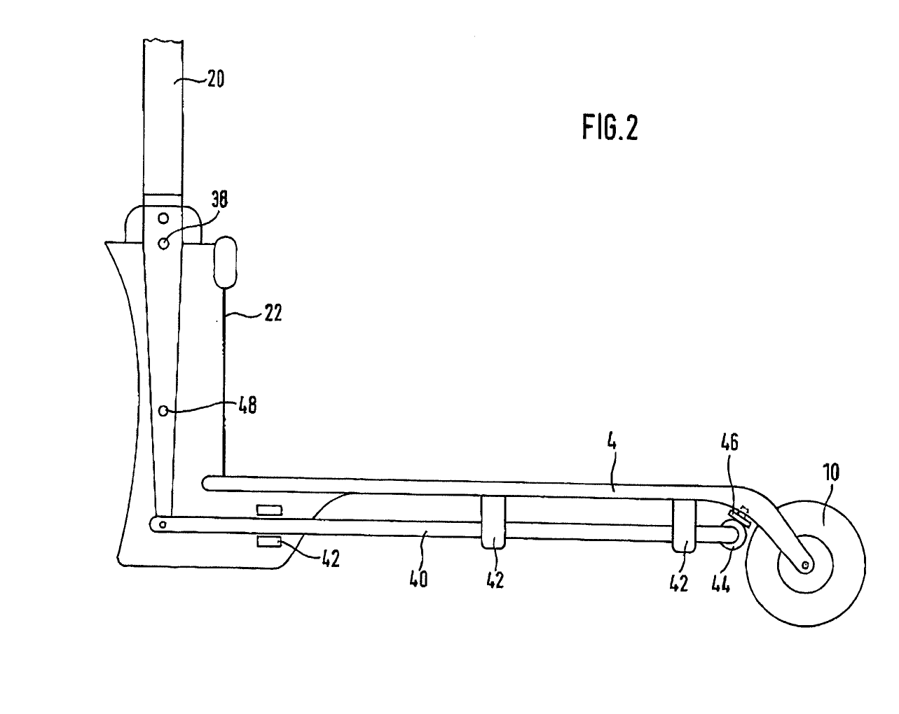

FIG. 2 shows details of a brake means of a roller board;

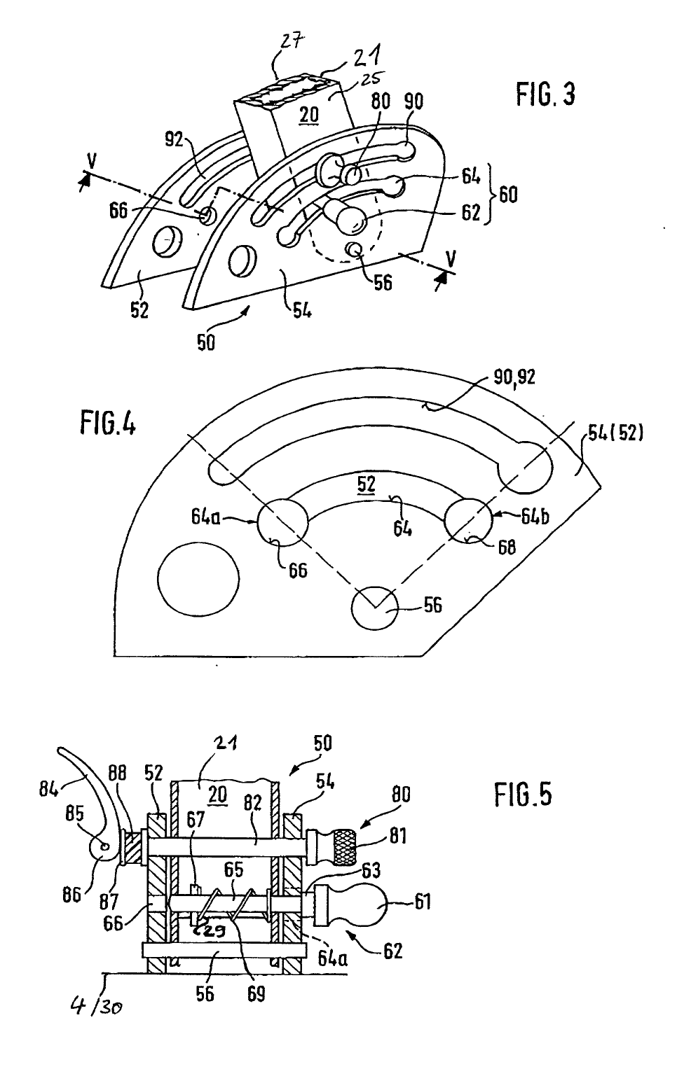

FIG. 3 shows a perspective view of a pivot bearing illustrated schematically in FIG. 1;

FIG. 4 shows a side view of two guide plates of the pivot bearing according to FIG. 3, which are aligned with each other in viewing direction of the figure;

FIG. 5 shows a radial sectional view of the pivot bearing according to FIG. 3 in an intermediate position between two locking positions;

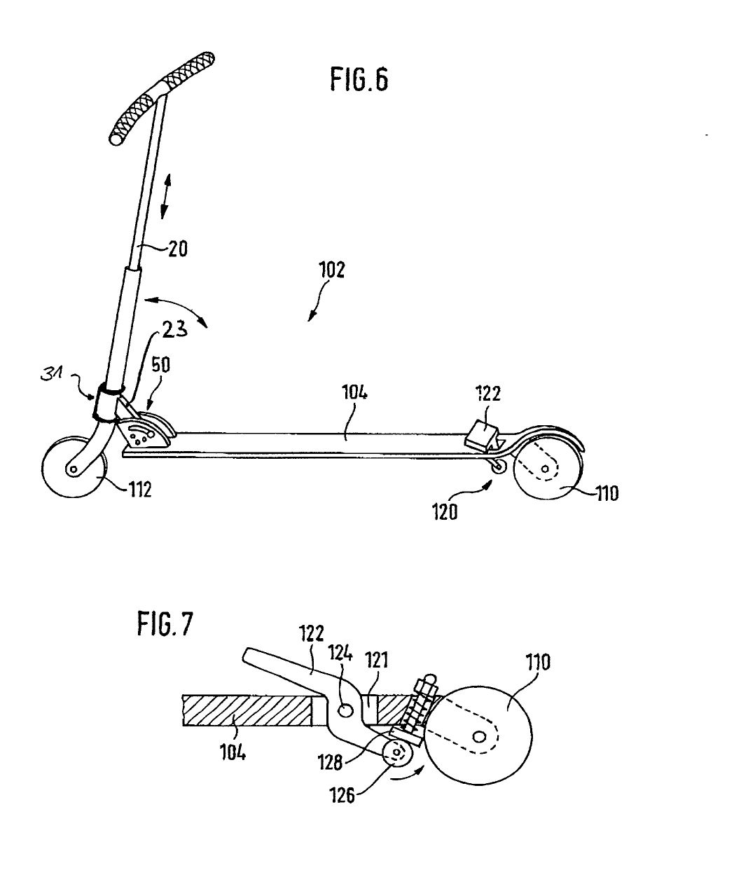

FIG. 6 shows a second embodiment of a roller board according to the invention, comprising a pivot bearing as illustrated in FIGS. 3 to 5 as well as an alternative brake means; and

FIG. 7 shows an enlarged view of the brake means illustrated schematically in FIG. 6.

FIG. 1 illustrates a roller board 2 comprising a footboard 4 on which a user can stand during use of the board. Footboard 4 has a front end portion 6 in running direction and a rear end portion 8 in running direction. In addition thereto, a wheel 10 is rotably mounted at the rear end portion of the footboard. In the region of the front end portion 6 of footboard 6, there are provided two wheels 12, 14 connected to each other on an axle 16. Wheels 12, 14 are connected via a steering mechanism 18 to footboard 6. Steering mechanism 18 has a control rod 20 mounted thereon.

Steering mechanism 18 in essence has three individual parts: connecting member 22 for connection to the footboard 6, intermediate member 24 and swivelling bolster 26 having attached thereto the axle 16 with wheels 12, 14. Intermediate member 24 is mounted to connecting member 22 via longitudinal pivot axle 28. Swivelling bolster 26 is mounted on intermediate member 24 so as to be rotatable about the front wheel steering axle 30. The axles 28, 30 may be, for example, pins or bolts attached to one of the two mutually rotatable members and rotatably supported in the other one thereof in a cylindrical bore. The swivelling bolster 26 has a shaft-like pin 32 mounted thereon guided in an entraining means 34 attached to connecting member 22, in particular in an opening 36 thereof. If, in use, i.e. during a ride, the footboard 4 is tilted with rear wheel 10 around the longitudinal pivot axle 28 by means of control rod 20, the entraining means 34 takes pin 32 along and rotates swivelling bolster 26 along with axle 26 and wheels 12, 14 around the front wheel steering axle 30. The front wheels 12, 14 are thus turned into a corner. Control rod 20 is attached to footboard 4 via connecting member 22 of steering mechanism 18.

Control rod 20 is coupled to connecting member 22 via a pivot bearing 50 in such a manner that, after opening of an arresting means and release of a locking pin, it can be folded rearwardly into the position shown in broken lines. In this configuration, roller board 2 can be stowed away and transported more easily.

The footboard 4 can be formed, for example, of wood or plastics material. However, it may also be made e.g. of metal, in particular a light metal such as aluminum. The connecting member 22, the intermediate member 24 and the swivelling bolster expediently are made of metal as well. Die-cast metal parts are especially expedient in manufacture. It is possible to form the entraining means 34 integrally with the connecting member 22. As an alternative, it is also possible to extend the pin 32 up to the connecting member 22 proper and to guide it e.g. in an opening there. To avoid play between the opening 36 in case of entraining means 22 or between the corresponding opening directly in member 22 and the shaftlike pin 32, pin 32 may be guided, for example, in a socket of elastically resilient plastics material.

In the region of the longitudinal pivot axle and/or the front wheel steering axle, there may be provided additional elements, for example helical springs or other socket-like parts of resiliently elastic material, which take care that the intermediate member 24 is mounted on connecting member 22 and, respectively, that the swivelling bolster 26 is mounted on intermediate member 24 in such a manner that these, when there are no forces acting thereon, return to the neutral position, i.e. to a position in which the roller board 2 runs straight forward. A resetting means may also be provided in that the front wheel longitudinal axle 30 is not provided at right angles to the longitudinal pivot axle 28, but is arranged at an angle thereto which is somewhat smaller or somewhat larger than the right angle. This has the effect that the plane in which the axle 16 and the wheels 12, 14, respectively, turn with respect to intermediate member 24 is slightly tilted forwardly in downward direction and rearwardly in downward direction, respectively. The force of gravity and in particular the weight of the user standing on footboard 4 then provides for return to the neutral position. On the other hand, the geometric arrangement of the longitudinal pivot axle, which in its extension runs clearly above the rear wheel 10, also provides for resetting to the neutral position due to the force of gravity since, by lateral pivoting of footboard 4, said footboard 4 is lifted in its front portion. The weight of the user has the tendency to turn the footboard 4 again into the energetically most appropriate, i.e. lowest position. This position is the neutral position.

The afore-mentioned pivot bearing 50, which connects control rod 20 to footboard 4 via the connecting member 22 or the mounting member 23 (cf. FIG. 6), has a pair of guide plates 52 and 54 extending parallel to each other and in longitudinal direction of roller board 2 each; guide plates 52 and 54, in the direction perpendicularly to their planes, have a pivot axle 56 passing therethrough on which the lower end of control rod 20 or mounting member 23, respectively, is supported. Both of said guide plates 52 and 54 are formed with a locking mechanism and an arresting means, which will be described in more detail hereinafter. The arresting means includes a lever 84 which, upon opening thereof, releases a pin, not shown in FIG. 1, so that control rod 20 may be folded in the direction of footboard 4. Folding of control rod 20 is indicated by a double arrow.

FIG. 2 shows a brake means operated via control rod 20. Control rod 20 is attached to connecting member 22 so as to be pivotable in forward direction and rearward direction around axle 38. Control rod 20 continues downwardly into connecting member 22 and at the lower end thereof is connected to a thrust bar 40. Thrust bar 40 is guided by guide elements 42 on the bottom side of footboard 4. At the rear end of thrust bar 40, there is mounted a brake roller 44 adapted to cooperate with rear wheel 10. Moreover, there is provided a brake pad 46 arranged in spring-loaded manner opposite brake roller 44. Control rod 20 is normally held by a brake locking means, shown in FIG. 2 in the form of pins 48 laterally projecting from the lower extension of control rod 20 into corresponding openings in connecting member 22. The at least one pin 48 can be retracted by actuation of an unlocking means, not shown, into the lower extension of control rod 20, whereupon control rod 20 can be pivoted forwardly around fulcrum 38. Forward pivoting of control rod 20 effects a displacement of thrust bar 40 in the direction towards the rear wheel. At the same time, brake roller 44 is engaged with the rear wheel, and upon further movement to the rear is increasingly engaged with brake pad 46, which finally causes a braking effect of the rear wheel.

The material chosen for brake pad 46, brake roller 44 and rear wheel is preferably such that brake roller 44 does not block on rear wheel 10, but that the frictional engagement actually is effected between brake pad 46 and frictional roller 44, whereas the brake roller 44 just transfers the deceleration to the rear wheel.

The unlocking means may be, for example, a lever of the type of a bicycle brake lever, which is provided at the upper end of control rod 20 and from which e.g. a Bowden wire transfers the unlocking motion downwardly onto pins 48. A simple reversing mechanism may be provided e.g. in the lower extension of control rod 20 for retracting the pins 48 into the rod upon an unlocking motion.

FIG. 3 shows pivot bearing 50, illustrated schematically in FIG. 1, for coupling control rod 20 to footboard 4. Pivot bearing 50 comprises the pair of guide plates 52 and 54 welded to intermediate member 22 (in the embodiment of FIG. 1) or to footboard 4 or another (not shown) mounting plate which in turn is threadedly attached to footboard 4 (in the embodiment of FIG. 6). FIG. 4 shows guide plates 90 and 92 aligned with each other in axial direction of pivot axle 56.

Concentrically with pivot axle 56, the two guide plates 52 and 54 each have an elongate guide hole 90 and 92 formed therein. Guide plate 54 has a locking pin guide means 64 formed therein, which at both ends thereof is formed with locking recesses 64a and 64b, respectively. In alignment with these locking recesses 64a and 64b, the other (in FIG. 4 rear) guide plate 52 is formed with locking holes 66 and 68, the function of which will still be described further below.

A locking pin 62 (FIG. 3) extends through locking pin guide means 64 and the lower end of control rod 20 or mounting member 23, respectively, and is part of a locking mechanism 60 by means of which control rod 20 can be locked in a forward locking position (to the right in FIG. 2) or in a rear locking position (to the left in FIG. 3). An arresting means 80 extends through both elongate guide holes 90, 92 in the two guide plates and moreover through the lower end of control rod 20 or mounting member 23, respectively. At the end not visible in FIG. 3, the arresting means has a clamping mechanism so that the control rod can be clampingly arrested in addition in the forward or rear latching position in accordance with latching recess 64a or 64b.

FIG. 5 illustrates a radial sectional view of pivot bearing 50. Between the two guide plates 52 and 54, there is located the lower end of control rod 20 or mounting member 23, respectively, such that control rod 20 is pivotable around pivot axle 56. Locking mechanism 60 comprises locking pin 62 with a handle 61 on its end side and with a shaft portion 65, with a locking piece 63 being arranged between shaft portion 65 and handle 61. This locking piece 63 has a diameter greater than that of the width of locking pin guide means 64 in guide plate 54 (cp. FIG. 4) and slightly smaller than the diameter of the two locking recesses 64a and 64b of guide plate 54. The diameter of shaft portion 65 is slightly smaller than the diameter of the two locking holes 66 and 68 (FIG. 5 shows one locking hole 66 in accordance with the displaced sectional plane V-V in FIG. 3; locking recess 64a is shown in broken lines in FIG. 5).

When control rod 20 is in a position in which locking pin 52 is aligned with one of locking recesses 64a or 64b, locking pin 62 is displaced towards the left in FIG. 5. This is obtained by virtue of spring 79 urged against a disk 67 fixed on shaft portion 65 and being supported on the inner wall of control rod 20 or mounting member 23, respectively.

Due to the displacement of locking pin 62 to the left in accordance with FIG. 5, the front end of shaft portion 65 becomes locked in locking hole 66 and locking piece 63 is simultaneously locked in locking recess 64a. As the locking pin extends through the lower end of control rod 20 or mounting member, respectively, fixation thereof is thus obtained.

For additional arresting of control rod 20, there is provided an arresting means 80, comprising a trunnion 82 provided with a head 81, with a lever 84 being supported on a bearing pin 85 at the end remote from head 81, said bearing pin 85 extending through trunnion 82 at right angles thereto. In the region of bearing pin 85, lever 84 is in the form of a cam member through which rubber sleeve 88 can be urged against the outside of guide plate 52 for arresting control rod 20 by frictionally engaging trunnion 82 with both guide plates 52 and 54 and by positive engagement thereof in control rod 20 and mounting member 23, respectively. For pivoting the control rod 20, the arresting means is released by pivoting lever 84, locking pin 62 is released by pulling on handle 61, whereupon control rod 20 can be pivoted.

It can be seen from FIGS. 3 and 5 that the lower end of control rod 20 or mounting member 23 is of rounded configuration. This rounded design provides the advantage that the front wall 21 of control rod 20 or mounting member 23, respectively, by far does not extend downwardly to such an extent as side walls 25, 27. The illustration of FIG. 5 reveals the lower end 29 of front wall 21. In particular, it can be seen that there is a sufficient distance present between the lower end 29 of front wall 21 and footboard 4 or mounting plate 30, respectively, to prevent clamping of objects or body parts therebetween. The distance should have approximately a finger's width. About 1 cm or more are particularly advantageous. The edges in this region are rounded so that, if clamping in should occur nevertheless, this region cannot have the effect of a cutting edge.

FIGS. 6 and 7 show an alternative embodiment of a roller board 102 having a footboard 104 having a (single) front wheel 112 and a rear wheel 102. The pivot bearing 50, which has already been described in detail hereinbefore, is provided in the forward portion of footboard 104. In this embodiment, control rod 20 is rotatably supported in a steering head bearing 31 in similar manner to a bicycle. Steering head bearing 31 and thus control rod 20 are connected to the footboard via a mounting member 23 and pivot bearing 50.

FIGS. 6 and 7 illustrate a brake means 120 in the form of a foot brake, having a foot brake lever 122, in the rear end portion of footboard 104.

As can be seen from FIG. 7, foot brake lever 122 is supported in a recess 121 of footboard 104 by means of a bearing pin 124. By means of a spring (not shown), foot brake lever 122 can be biassed in clockwise direction in accordance with FIG. 7. If the user of the roller board steps with his heel on foot brake lever 122, the latter is pivoted in counterclockwise direction so that a brake roller 126 supported at the lower end of foot brake lever 122 acts against a spring-biased brake pad 128 and at the same time against the outer surface of rear wheel 110, thereby decelerating rear wheel 110.

Brake pad 128 is held by a pin 126 having a spring arranged thereon which is secured by a nut at the end of the pin, so that the brake pad is urged against brake roller 126. The spring indicated in FIG. 7, applying a spring load to the brake pad, may serve at the same time for biasing the foot brake lever 122 to the rest position.

1. A roller board (2) having a longitudinal axis extending in running direction, comprising:
(a) a footboard (4) provided for a user to stand thereon and having front and rear end portions (6, 8) in running direction;
(b) at least one wheel (10) provided at the rear end portion (8) of said footboard (4),
(c) two steerable wheels (12; 14) provided at the front end portion of said footboard each offset to a side of said longitudinal axis,
(d) a steering mechanism (18) having the two steerable wheels (12; 14) mounted thereon and being mounted at the front end portion (8) of the footboard (4) such that pivoting of said footboard (4) about its longitudinal axis effects turning of said front wheels (12; 14); and
(e) a control rod (20) connected to the footboard (4) and adapted to be held by the user during his ride,
characterized in
that the steering mechanism (18) is designed such that the two front wheels (12; 14) are adapted to be turned in common around a common front wheel steering axle (30) which, in the neutral position, is substantially perpendicular to the connecting line (16) between the two front wheels and substantially vertical to said longitudinal axis (28).

2. A roller board (2) according to claim 1, characterized in that a resetting means is provided which endeavors to reset the deflected front wheels (12; 14) to the neutral position.

3. A roller board (2) according to claim 2, characterized in that the resetting means is constituted by the front wheel steering axle (30) by arranging the same at an angle with respect to the longitudinal axis (28) which is somewhat smaller or somewhat greater than a right angle.

4. A roller board (2) according to claim 1, characterized in that the steering mechanism (18) has a longitudinal pivot axle (28) around which the footboard (4) is pivotable relative to the front wheels (12; 14) and which in its function is provided between front wheel steering axle (30) and footboard (4).

5. A roller board (2) according to claim 4, characterized in that there is provided an entraining mechanism (32; 34) converting a pivotal motion of the footboard (4) into a steering motion of the front wheels (12; 14) around the front wheel steering axle (30).

6. A roller board according to claim 1, characterized in that the control rod (20) is coupled to the footboard via a pivot bearing by means of which the control rod is adapted to be folded onto the footboard (4, 104).

7. A roller board according to claim 6, characterized in that the pivot bearing (50) has an arresting means (80) associated therewith.

8. A roller board (2) having a longitudinal axis extending in running direction, comprising:
(a) a footboard (4) provided for a user to stand thereon and having front and rear end portions (6, 8) in running direction;
(b) at least one wheel (10) provided at the rear end portion (8) of said footboard (4),
(c) at least one steerable wheel (12) provided at the front end portion of the footboard, and
(d) a control rod (14) connected to the footboard (4) and adapted to be held by the user with a hand during the ride and coupled to said footboard (4) via a pivot bearing (50),
characterized in
that there is provided a locking means for securing the control rod (14) in the unfolded position and, in addition thereto, the pivot bearing (50) has an arresting means (80) associated therewith.

9. A roller board (2) according to claim 8, characterized in that the pivot bearing has a pair of guide plates (52, 54) between which the lower end of the control rod (20) is supported on a pivot axle (56), and that at least one of the guide plates (52, 54) and the lower end of the control rod (20) are penetrated by a locking pin (62) adapted to be displaced between a release position and a locking position approximately at right angles to the pivot plane of the control rod (20).

10. A roller board (2) according to claim 9, characterized in that one (54) of the guide plates (52, 54) has an arcuate locking pin guide means (64) formed therein which is concentric with respect to the pivot axle (56) and has a locking position defined at each of its ends.

11. A roller board (2) according to claim 9, characterized in that the arresting means (80) in each of the guide plates (52, 54) has an arcuate elongate guide hole (90, 92) which is concentric with respect to the pivot axle (56) and through each of which extends a trunnion (52), coupled to the control rod (20), at right angles to the pivot plane of the control rod (20), with said trunnion being adapted to be arrested by a clamping mechanism (84-88) at the paired ends of the elongate guide holes (90, 92).

12. A roller board (2) according to claim 8, characterized in that the pivot bearing (50) is releasably mounted to the footboard (4).

13. A roller board (2) according to claim 8, characterized in that the lower end of the control rod (20) is designed such that, in the unfolded state of the control rod (20), a sufficiently large distance is left between the lower end of the control rod (20) and the footboard (4), so that it is substantially avoided that objects or body parts become clamped therebetween.

14. A roller board (2) according to claim 13, characterized in that the lower end of the control rod (20) is tapered such that a sufficiently large distance is created between this end (28) and the footboard (4).

15. A roller board (2) according to claim 13, characterized in that the lower end of the control rod (20) is closed.

16. A roller board (2) according to claim 1 or 8, characterized in that there is provided a brake means.

17. A roller board (2) according to claim 16, characterized in that brake means is connected to the control rod (20) such that pivoting of control rod (20) in forward direction initiates a braking operation.

18. A roller board (2) according to claim 17, characterized in that there is provided a brake locking means (48) having an unlocking means at the upper end of the control rod (20), which permits pivoting of the control rod (20) in forward direction after operation of said unlocking means only.

19. A roller board (2) according to claim 16, characterized in that the brake means has at least one brake roller (44) and at least one displacement means (40) which, for effecting a braking operation, brings the at least one brake roller (44) in contact with at least one of the wheels (10).

20. A roller board according to claim 16, characterized in that the brake means (120) has a foot brake lever (122) pivotably supported at the rear end portion of the footboard (104), which is coupled to a friction mechanism (126, 128) acting on the rear wheel (10).
